(19) United States
(12) Patent Application Publication
(10) Pub. No.: US 2019/0049988 A1
(43) Pub. Date: Feb. 14, 2019

(54) Autonomous Food Delivery Vehicle

(71) Applicant: Domino's Pizza Enterprises Limited, Hamilton, Queensland (AU)

(72) Inventor: Donald Jeffrey Meij, Hamilton, Queensland (AU)

(21) Appl. No.: 16/085,785

(22) PCT Filed: Mar. 16, 2017
(86) PCT No.: PCT/AU2017/050234

§ 371 Date: Sep. 17, 2018

(30) Foreign Application Priority Data
Mar. 16, 2016 (AU) 2016900991

(51) Int. Cl. G05D 1/02; G05D 1/00; G06Q 10/08; G06Q 50/12

(52) U.S. Cl. CPC G05D 1/0246; G05D 1/0274; G05D 2201/0213; G06Q 10/083; G06Q 50/12; G05D 1/0088

(57) ABSTRACT

An autonomous delivery vehicle including a motorized, mobile base unit, an on-board computer configured with software for navigation and collision avoidance, and a delivery unit mounted to the mobile base unit for containing one or more items during delivery to allow a customer to remove items stored therein once the delivery vehicle has reached a delivery location.

### TECHNICAL FIELD

The present invention relates to an autonomous delivery vehicle and system.

### BACKGROUND ART

An autonomous car (driverless car, self-driving car, robotic car) is a vehicle that is capable of sensing its environment and navigating without human input.

Autonomous vehicles detect surroundings using radar, lidar, GPS, odometry, and/or computer vision. Advanced control systems interpret sensory information to identify appropriate navigation paths, as well as obstacles and relevant signage. Autonomous cars have control systems that are capable of analysing sensory data to distinguish between different cars on the road, which is very useful in planning a path to the desired destination.

It will be clearly understood that, if a prior art publication is referred to herein, this reference does not constitute an admission that the publication forms part of the common general knowledge in the art in Australia or in any other country.

### SUMMARY OF INVENTION

The present invention is directed to an autonomous food delivery vehicle, which may at least partially overcome at least one of the abovementioned disadvantages or provide the consumer with a useful or commercial choice.

With the foregoing in view, In another form, the present invention in one form, resides broadly in an autonomous delivery vehicle including
a) a motorised, mobile base unit;
b) an on-board computer configured with software for navigation and collision avoidance;
c) a wireless communication module to enable sending and receiving of information to and from the delivery vehicle;
d) at least one location receiver to obtain location data indicative of a location of the vehicle in real time or near real time;
e) at least one detection device to detect features in the local environment for navigation and collision avoidance; and
f) a delivery unit mounted to the mobile base unit for containing one or more items during delivery to allow a customer to remove items stored therein once the delivery vehicle has reached a delivery location.

The delivery unit mounted to the mobile base unit preferably has a deployable portion, movable between a stored position for containing one or more items during delivery and a service position wherein the deployable portion is at least partially outside the delivery unit to allow a customer to remove items stored therein.

The autonomous delivery vehicle preferably has at least one visual indicator which is variable to indicate the delivery status of the delivery vehicle.

The on-board computer of the autonomous delivery vehicle preferably operates an onboard software application which controls operation of the vehicle and the components thereof.

In another form, the present invention includes an autonomous food delivery system including
a) An autonomous delivery vehicle including a motorised, mobile base unit; an on-board computer configured with software for navigation and collision avoidance; a wireless communication module to enable sending and receiving of information to and from the delivery vehicle; at least one location receiver to obtain location data indicative of a location of the vehicle in real time or near real time; at least one detection device to detect features in the local environment for navigation and collision avoidance; and a delivery unit mounted to the mobile base unit for containing one or more items during delivery to allow a customer to remove items stored therein once the delivery vehicle has reached a delivery location;
b) One or more processing systems operating substantially without human intervention and having a communication module to enable sending and receiving of information to and from the delivery vehicle, the one or more processing systems configured to assist the autonomous delivery vehicle with navigation from a home base to a delivery location and back to the home base and collision avoidance whilst in transit.

The autonomous delivery vehicle of the present invention can be utilised to deliver any type of item. In the context of the present specification, the autonomous delivery vehicle is discussed particularly in terms of delivery of fresh or prepared food, and particularly, home delivery of a meal provided by a food preparation store. The vehicle can deliver food that has been prepared at the food preparation store which is hot and/or cold. For the purposes of the present invention, the term “food” includes beverages as well.

Typically, the autonomous delivery vehicle will be loaded with prepared food at a home base, normally the food preparation store and the delivery location is provided to the vehicle. The vehicle is then “locked”, leaves the food preparation store, and navigates autonomously to one or more delivery locations where a customer can access the food for removal after an appropriate verification process has taken place, and the autonomous vehicle then navigates back to the home base (or to one or more further delivery locations and then back to the home base) for further deployment or storage.

The autonomous vehicle of the present invention typically utilises a motorised base unit having available technology for providing a mobile base unit which is capable of navigation and collision avoidance in order to autonomously move from one location to another. The vehicle will typically be speed limited. The vehicle will normally be software controlled in order to be substantially autonomous and may be provided with an artificial intelligence allowing self navigation and collision avoidance, but with human intervention possible in situations that the software cannot overcome.

Generally, the vehicle will be relatively small, having a footprint of approximately 1 m×1 m but the weight of the vehicle will typically be substantial, mainly due to the inclusion of the power plant in the vehicle. In some embodiments, the vehicle may weigh approximately 250 kg.

The vehicle will typically be an electric vehicle, but alternative power plants may be provided. According to a preferred embodiment, the vehicle will normally have one or more on-board storage batteries which can be recharged in order to provide power to one or more electric motors to drive the preferred wheels. It is preferred that the vehicle be provided with at least 4 wheels and a four-wheel-drive operation is preferred for safety and stability reasons. Preferably, wheels are provided rather than tracks in order to limit maintenance and the potential for damage. The wheels will preferably be puncture proof or run flats.

As will be relatively clear from the above, the vehicle will typically be self driving and self navigating. The vehicle will typically be capable of operating over substantial distances, preferably up to approximately 20 to 30 km. The vehicle will be capable of out of line of sight operation.

The vehicle of the present invention includes a motorised base unit. Preferably, the motorised base unit will be self-contained, mobile and operate substantially autonomously during the delivery process. Typically, the motorised base unit is generally rectangular being provided with at least 4 wheels, one at each of the corners of the generally rectangular unit. The delivery unit is preferably located on top of the motorised base unit and separated from the base unit, normally through the provision of an intervening wall or similar. Preferably, a neck portion will be provided between the motorised base unit and the delivery unit and both the delivery unit and the motorised base unit are typically larger than the neck portion.

As mentioned above, it is preferred that the motorised base unit be powered electrically and include one or more on-board batteries. The weight of the batteries in the base unit will typically increase the stability of the base unit and reduce the chance that the vehicle will tip.

The motorised base unit may be made from any material, but typically, the drive and operational components of the base unit will be contained in a metal enclosure within the base unit but one or more external panels of the motorised base unit may be provided manufactured from different materials for aesthetic purposes.

The motorised base unit will typically include at least one, and typically a number of different illumination sources, with illumination sources provided for different purposes. Preferably, lighting is provided beneath the motorised base unit to illuminate downwardly in order to show the path or the road surface over which the base unit is travelling. An upper portion of the motorised base unit may be provided with upwardly directed lighting in order to illuminate the food delivery unit. The motorised base unit may be provided with lighting directed forwardly and/or lighting directed rearwardly so that the vehicle can be easily identified or signal.

Whilst illumination sources will typically be provided, it is also preferred that other visual indicia be provided such as reflective portions, luminescent portions, photoluminescent portions and the like in order that the motorised base unit and the autonomous vehicle in general be identified well and capable of being clearly seen, even in low light conditions.

One or more cameras or other image capturing devices may be provided on the motorised base unit or the delivery vehicle in general in order to monitor and/or capture the surrounds whilst the vehicle is on delivery. Normally, this will be capture of images on a real time, and preferably substantially continuous basis by video capture. The captured images may be transmitted to a remote locality for monitoring and/or stored on board.

The motorised base unit will typically operate on skid steer principles in order to provide a very small turning circle and high manoeuvrability. The motorised base unit will be of robust construction given that it will likely be deployed into adverse weather conditions and possibly adverse travel conditions. The motorised base unit will also typically be substantially waterproof in order to protect the components within.

The autonomous delivery vehicle of the present invention also includes an on-board computer configured with software for navigation and collision avoidance. The on-board software will typically allow autonomous operation to travel from the home base to one or more delivery locations and return to home base substantially without human intervention unless human intervention is required for situations not solvable by the software.

Normally, the on-board computer will be associated with the wireless communications module, the location receiver and the at least one detection device and will typically use inputs and/or outputs from these components to autonomously navigate from the home base to the at least one delivery location and return to the home base with the navigation including avoidance of collisions during the travel.

The on-board computer will typically operate navigation and collision avoidance software but the on-board computer will also typically include a software application to accomplish or partake in the customer identity verification process at each delivery location, before the deployable portion is deployed. The on-board computer will therefore have one or more separate subsystems with at least one subsystem including hardware and software allowing autonomous navigation and collision avoidance of the vehicle to one or more delivery locations, and at least one subsystem including hardware and software controlling access to the food delivery unit.

The on-board computer is typically capable of receiving delivery instructions from a point of sale or store management computer system in order to obtain the one or more delivery locations and/or other information required or helpful in the delivery process. The on-board computer is preferably also capable of obtaining or being provided with real-time map or routing information for use in navigation and/or collision avoidance.

The autonomous delivery vehicle of the present invention also includes at least one wireless communications module allowing for communication to and/or from the vehicle. In this way, the autonomous delivery vehicle can send and receive information in relation to its location and status and receive updates to allow more efficient operation and/or delivery. Normally, instructions are issued to the on-board computer of the autonomous delivery vehicle via the at least one wireless communications module. Requests from the autonomous vehicle for further information or instructions can be sent via the at least one wireless communications module, updates can be received substantially in real time and importantly, second-by-second data as to the location and speed of the vehicle and/or vector data can be provided from the autonomous delivery vehicle to a remote monitoring system. Preferably, the at least one wireless communication module will send second-by-second data as to the location and speed of the vehicle as well as vector data to at least one remote location, normally to a monitoring system to allow the monitoring system to convey this information to the home base (the information can be sent directly to the home base) and/or other interested parties such as for example, the ordering customer as be explained further below.

The autonomous delivery vehicle of the present invention also includes at least one detection device to detect features in the local environment for navigation and collision avoidance. One or more detection devices can be used and any type or combination of detection devices can be used. Particularly preferred are devices that allow the autonomous delivery vehicle to navigate and identify objects using radar, lidar, location technologies such as GPS, odometry and/or computer-aided vision, virtual reality or augmented reality technology. Lidar is particularly preferred for use as the primary detection mechanism and appropriate hardware and (on-board) software is typically provided.

The autonomous delivery vehicle of the present invention also includes a delivery unit mounted to the mobile base unit for containing one or more items during delivery to allow a customer to remove items stored therein once the delivery vehicle has reached a delivery location. As mentioned above, the delivery unit is typically mounted to the motorised base unit, above the base unit, typically on a neck portion.

The delivery unit preferably includes an external housing. The external housing will normally define an outer shape of the delivery unit and is preferably at least partially arcuate for aesthetic reasons. The housing may have a substantially planar front wall and rear wall. Normally, one or more lights are provided on the front wall and/or rear wall. In particular, the front of the delivery unit is typically provided with one or more headlights in order to illuminate forwardly of the food delivery vehicle and the headlights are normally not coloured lights. In contrast, the rear of the delivery unit is typically provided with one or more tail lights and/or brake lights, normally red lights, in order to allow a user to more easily identify the autonomous vehicle and/or indicate to users located rearwardly of the vehicle when the vehicle is braking.

The external housing of the delivery unit is typically at least partially hollow defining an internal volume. At least one deployable portion is located within the internal volume of the food delivery unit. The at least one deployable portions is located within the internal volume in the delivery condition and is selectively deployable to a location partially outside the external housing to allow a customer to access and remove the food preferably stored within the at least one deployable portion. In a preferred embodiment, the deployable portion will preferably raise and lower substantially vertically relative to the external housing as this will contribute to maintaining the stability of the vehicle but a deployable portion may deploy in any direction.

More than one deployable portion may be provided and if so, each deployable portion may deploy in different directions however this will typically have an adverse impact on the volume of each of the deployable portions so provision of a single deployable portion is preferred.

The at least one deployable portion may be divided internally into one or more compartments. The compartments provided may be individually accessible and access to each may be controlled, preferably by the on-board computer and software according to the make up of the particular delivery or deliveries that the vehicle is making. For example, each compartment may be provided with a door which is lockable and access to any compartment is typically controlled via the verification process. Verification may trigger deployment of the deployable portion and the unlocking of the compartment door.

It is further preferred that the least one deployable portion may be divided into different functionalities for example, some of the compartments may be heated or hot compartments adapted to temporarily store heated food and some of the compartments may be cooled or cold compartments adapted to temporarily store cooled or frozen food. Where these different functionalities are provided in the same deployable portion, it is preferred that the compartments may be visually distinct from one another, for example, using colour coding to represent the different functionalities. In one preferred embodiment, the cool or cold compartments may be provided with blue colouring or highlights and the warm or hot compartments provided with red colouring or highlights in order to allow the customer to easily identify the function of the compartments. This may also increase the safety of the device with the customer being warned of warm or hot compartments prior to making contact with those compartments.

Typically, heated or hot compartments may be insulated and thereby provide passive heat maintenance or alternatively, the compartments can be provided with one or more active heat components. Similarly, cooled or cold compartments may be insulated, providing passive cooling maintenance or alternatively, the compartments can be provided with one or more active cooling components. In some embodiments, a combination of insulation and active components can be provided. Where active heating and/or cooling components are provided, these will normally be powered from the vehicle power supply, typically accessing power from the motorised base unit power supply.

In a particularly preferred embodiment, the delivery unit will typically deploy once the delivery location has been reached and the customer identification verification process has been completed. Normally, the satisfaction of both parameters will be required before deployment commences. The verification process will typically be achieved through the provision of a verification code or identifier by the customer to the autonomous delivery vehicle and preferably, to the software operating on the on-board computer in order to be compared against a verification code or identifier provided at the time the order is made. Typically, the verification code or identifier is created and/or issued upon payment for the order by the ordering customer and is typically provided to the ordering customer upon payment. This is typically achieved using a personal computing device such as a tablet or smart phone or the like, upon which the majority of ordering customers now order this type of delivery. In this case, the verification code or identifier can be provided directly to the personal computing device of the ordering customer. If the order is made on a non-mobile computing device, the customer can elect to have the verification code or identifier forwarded to a mobile or personal computing device.

Other verification systems may be used. For example, one or more verification systems involving biometric data unique to a customer may be used. For example, a unique fingerprint, optical scan or even a mechanism including a physical sample such as breath or skin for example may be used. If implemented in this configuration, each customer will typically require a unique profile to be created which stores at at least one biometric control sample of data which is unique to each customer. The biometric control sample can be created or captured in any way and typically, the customer will provide the biometric control sample to be stored against their unique customer profile. Normally the profiles will be stored in at least one database accessible by the one or more processing systems. During the verification process, the autonomous delivery vehicle will typically access the ordering customers unique profile in order to compare a biometric sample provided during the verification process by the customer, with the at least one biometric control sample stored in the unique customer profile and if there is a match, then the deployable portion will typically open and if there is not a match, the customer can be prompted to retry and/or failure to provide a matching biometric sample will result in the deployable portion remaining locked and potentially, the autonomous delivery vehicle returning to home base.

Typically, the ordering customer will take the device upon which the order was made or the mobile or personal computing device to which the verification code or identifier was forwarded with them to collect their food from the autonomous food delivery vehicle. The verification process can be initiated a variety of ways, one way in which it may be initiated is simply through proximity of the mobile or personal computing device to the autonomous food delivery vehicle. In other words, once the mobile or personal computing device moves within range of the autonomous food delivery vehicle, the verification process may be initiated automatically. Alternatively, the verification process may be manually commenced by the customer once they are close to the autonomous food delivery vehicle.

Preferably, the at least one wireless communications module of the autonomous delivery vehicle may be used to communicate with the mobile or personal computing device of the customer. One mechanism for doing so is Bluetooth. For example, Bluetooth allows the identification of electronic devices to one another and either the autonomous delivery vehicle can “find the mobile or personal computing device of the customer or vice versa. Once a communication pathway has been established between the devices, the verification code may be transmitted from the mobile or personal computing device of the customer to the autonomous food delivery vehicle. The verification code received by the on-board computer of the autonomous delivery vehicle can be compared to the verification code created and/or issued upon payment for the order by the customer and if the verification codes match one another, then the deployable portion deploy is. If the verification codes do not match each other, then the deployable portion does not deploy, and remained secured with in the autonomous food delivery vehicle.

The verification process may include multifactor verification. For example, the verification process may include the verification code and additionally may require the presence of a particular mobile computing device from which the order was placed within a particular proximity to the autonomous delivery vehicle in order that the autonomous delivery vehicle can verify both the code, and that the code was issued to and from the particular mobile computing device.

The verification code creation and/or issue is typically undertaken by a software application which may be related to or associated with the software application through which the customer orders the food. The verification code software may allow the verification code to be sent or forwarded to a third-party to allow a third-party to receive delivery of the ordered food. For example, a parent may order a food delivery for children to be delivered to the children at a residential address and may therefore forward the verification code to the children to allow them to access the autonomous delivery vehicle to receive delivery of the food ordered by their parents if their parents are at a remote location from the residential address.

Once the verification process has been completed, that is the verification code provided to the autonomous delivery vehicle by the customer (preferably via a personal computing device) matches the verification code relating to the particular delivery provided by the ordering software, the deployable portion will deploy allowing the customer to remove the items from the deployable portion. The deployable portion will then close and lock in order to secure the deployable portion within the housing once more. The closing process may be actuated by the removal of items and therefore, one or more weight sensors may be provided in order to sense changes of weight in the deployable portion or alternatively, a manually actuable button or similar may be provided on the inside of the deployable portion in order to allow the customer to close the deployable portion once they have removed their food. Typically, safety features will be provided to prevent the deployable portion closing prematurely in order to minimise injury to customers or third parties.

The autonomous delivery vehicle may further include the ability for vehicle to contact the customer directly once the delivery location has been reached if verification is not initiated within a particular time period. This may include via text message or telephone with an automated message such as “your delivery has arrived and is awaiting collection”. Typically the contact details will be provided to the autonomous delivery vehicle with the order information and the onboard computer may action the contact if delivery location has been reached if verification is not initiated within a particular time period.

The autonomous delivery vehicle preferably has at least one visual indicator which is variable to indicate the delivery status of the food delivery vehicle. The at least one visual indicator will typically enable customers and third parties to distinguish between a delivery vehicle which is en route to a delivery location, allow identification of when verification is being undertaken and when a delivery vehicle is en route to the home base following a completed delivery to a customer. Typically, the at least one visual indicator will include one or more lights or similar and preferably, the lights will be capable of being lit in various colours to distinguish between the particular phases of delivery. Different coloured lights can be provided all one light system that is capable of being lit in different colours may be provided.

Although any colour system can be used, a preferred colour system may be designed in the corporate colours of the provider of the delivery service. For example, the colour red can be used to signify that the delivery vehicle is on the outbound leg to a delivery location, the colour blue can be used when the autonomous delivery vehicle is undertaking the verification process and the colour white can be used to signify that the delivery vehicle is on the return leg to the home base.

Preferably, the lighting system used for the visual indication of status is provided on or in association with the deployable portion. In a particularly preferred embodiment, a lighting strip is provided circumferentially at least partially about an upper portion of the deployable portion on top of the delivery unit as, from this position, it will typically be viewable easily, even from a distance.

The delivery unit will also typically be provided with advertising indicating the provider of the delivery service and the advertising will preferably be illuminated.

The autonomous delivery vehicle of the present invention will also typically include one or more antitheft or anti-tampering features in order to prevent theft or tampering with the food in the delivery unit and/or with the vehicle itself. For example, one or more alarms or warnings may be triggered if the food delivery vehicle is interrupted order averted or attempted to be interrupted or diverted from the plotted or selected delivery path. Typically, the warning will be issued, typically either audibly and/or visibly and if the warning is not effective, then a loud, audible alarm will typically be issued.

If the autonomous delivery vehicle is tampered with or an unauthorised attempt is made to divert the autonomous delivery vehicle from the plotted or selected delivery path, the one or more wheels on the motorised base unit may be locked, either by the on-board computer or remote monitoring station. Due to the preferred substantial weight of the device, this will make the device particularly difficult to move until the wheels are unlocked again.

Of course, at least one location receiver can be used to track the location of the vehicle in real time or near real time. The vehicle may also have the ability to automatically notify home base, or third-party such as a monitoring system or authorities such as the police if tampering or attempts are made to divert the vehicle.

Preferably, the housing of the delivery unit is robust in order to minimise any damage that may be inflicted on the delivery unit and to prevent access to the deployable portion and/or the food within and unless the verification process is undertaken.

The deployable portion into which food is placed for delivery may also be capable of preparing or cooking the food whilst the delivery is in progress. For example, the cooking time of various foods can usually be identified quite accurately. For example, the time taken to cook a pizza at a particular temperature will typically be more or less fixed. Generally speaking, the time taken to cook a pizza is less than the time taken to actually deliver the pizza if for example a pizza takes 8 minutes to cook but 20 minutes to reach the delivery location, then the pizza will not be as fresh as it could be because it will have been in the food delivery vehicle for 20 minutes after being cooked in store. In one embodiment, the deployable portion of the present invention may cook the food during the delivery process. The food may be prepared at a particular store or home base location, and loaded in an uncooked state into the deployable portion which is then locked in the delivery commences. The on-board software can then be instructed to commence cooking at an appropriate time during the delivery given the estimated time of arrival at the delivery location. In other words, a pizza can be loaded into the deployable portion in the raw form, and the cooking process can commence automatically approximately 8 minutes from the delivery location in order that the pizza arrive at the delivery location at substantially the same time that the cooking process ends. In this way, the customer can be provided with the freshest food possible and minimise the “dead” time in between cooking and the customer taking delivery of the food in which time, the food quality can deteriorate, sometimes quite rapidly. As the autonomous vehicle of the present invention can be programmed with the cooking time and is also capable of calculating the estimated time of arrival at the delivery location, the autonomous vehicle can be charged with starting the cooking and cooking the food whilst the delivery is underway in order to ensure that the food arrive at the delivery location at substantially the same time that the cooking process ends.

According to the system of the present invention, one or more processing systems may be provided for command and control in addition to the on-board software. Preferably, the system will provide for real-time tracking of the location and status of the autonomous delivery vehicle and for management thereof.

Instructions and/or updates can be sent from the one or more processing systems to the on-board computer and/or software for action. For example, a recall to base instruction can be issued, the vehicle can issue alerts to the home base, or one or more external systems can be provided to assist with an/or override the navigation and/or collision avoidance system is present in the vehicle. The one or more processing systems can additionally provide routing data updates in order to more efficiently plan the delivery and/or may plan delivery routs and transfer these to the autonomous food delivery vehicle.

The system of the present invention may include a subsystem for real-time or near real time monitoring of the autonomous food delivery vehicle, the system including a vehicle mounted device associated with each autonomous food delivery vehicle, a central server processing system and a home base work station located at the home base of each of the autonomous food delivery vehicles;
a) the vehicle mounted device including
   i. at least one location receiver to obtain location data indicative of a location of the autonomous delivery vehicle in real time or near real time,
   ii. a wireless communication module to transfer information relating to the location data and
   iii. at least one electrical connection assembly to connect the vehicle mounted device to a power supply system of the autonomous food delivery vehicle;
      at least one identification tool associated with the vehicle mounted device to uniquely identify the vehicle mounted device within the system,
b) the central server processing system to receive the location data from each vehicle mounted device and based on the location data, to transfer information relating to the real time or near real time location of each vehicle to the home base workstation; and
c) the home base work station including
   i. at least one electronic display with a map interface updated in real time or near real time indicating the real-time or near real time location of the autonomous food delivery vehicles on the map interface using the information transferred from the central server processing system;
   ii. at least one input device for input of data into the home base workstation; and
   iii. at least one identification tool reader to read the unique identification tool associated with each autonomous delivery vehicle mounted device to identify the vehicle mounted device as well as information and data pertaining thereto, within the system.

The subsystem is directed toward real-time monitoring of autonomous food delivery vehicles and the deliveries being delivered. The system of the present invention is based on interaction with an automated vehicle location system which may or may not be a proprietary system owned by third party.

It is preferred that the subsystem locate the autonomous food delivery vehicles through the vehicle mounted device in real time on near real-time. It is particularly preferred that the vehicle mounted device allow the location of the autonomous delivery vehicle based on information collected on a second by second basis and also vector data to compile and analyse vehicle behaviour. The collected information may be sent as collected or a packet of information collected over a period, preferably a short period, may be sent periodically. Due to the second by second data and vector data, the automated vehicle location system is typically able to give not only the location of the autonomous food delivery vehicles and but also the direction of travel of the vehicle and the speed of the vehicle due to the availability of the data used.

The subsystem includes multiple parts that operate together to track the location of the autonomous delivery vehicle through the vehicle mounted device and also to keep record of data from each autonomous delivery vehicle mounted device in order to keep the home base workstation informed and/or to log data in relation to each autonomous food delivery vehicle. This allows not only tracking of the autonomous food delivery vehicles, but also management of the autonomous food delivery vehicles, the deliveries themselves including dispatch management, safety record management, maintenance records and management-end forensic examination in case of any issues or problems.

The subsystem includes a vehicle mounted device associated with each vehicle. The vehicle mounted device may be mounted temporarily to the vehicle or but preferably permanently.

The vehicle mounted device includes at least one location receiver to obtain location data indicative of a location of the autonomous delivery vehicle in real time. As mentioned above, second by second and vector data is normally provided and this will allow the location and direction of travel of the vehicle to be determined substantially in real time or near real-time, limited only by the processing ability and connectivity of the system.

The at least one location receiver will typically interact with a location network to determine the location of the location receiver and thereby, determine the location of the vehicle. In a particularly preferred form, the at least one location receiver will be a GPS receiver.

Preferably, the location is determined as close as possible to real time. This is particularly powerful when based on second by second or breadcrumb data, as it allows the tracking of location precisely and preferably dynamically over time rather than prior art systems which only collect location data at particular time steps which can be separated by five or more seconds. Those systems give no feedback as to what has occurred between the time steps. In contrast, a second by second data feed allows capture of information on a second by second basis. The data collected is typically position or location data but due to the second by second data, this also allows the calculation of speed and direction based on the data.

The vehicle mounted device also preferably includes a wireless communications module to transfer information relating to the location data. The wireless communication module preferably transfers the information to the central server processing system of the present invention. The wireless communication module may be integrated with the location receiver or be separate thereto. Where separated, typically, the wireless communication module and the location receiver are provided in the same housing. This typically allows the wireless communication module and location receiver to draw power from the same source although this is not strictly necessary.

The wireless communication module can operate based on any wireless system, for example, cell phone networks, radio networks, data networks and the like. Most commonly, the location is determined using GPS, and the wireless communications module is based on SMS, GPRS, a satellite or terrestrial radio from the vehicle to a radio receiver. GSM is the most common services applied, because of the low data rate needed for automated vehicle location, and the low cost and near-ubiquitous nature of these networks. The low bandwidth requirements also allow for satellite technology to receive telemetry data at a moderately higher cost, but across a global coverage area and into very remote locations not covered well by terrestrial radio or public carriers.

The wireless communications module will typically have a hard wired connection to the power source and any interconnections with the location receiver but one or more wireless communications pathways from the wireless communications module.

The vehicle mounted device also preferably includes at least one electrical connection assembly to connect the vehicle mounted device to a power supply system of the autonomous food delivery vehicle. This preferably allows the autonomous delivery vehicle to provide the operating power to the vehicle mounted device and the components thereof. Typically, a hard wired connection is provided between the power supply system of the autonomous delivery vehicle and the vehicle mounted device. Normally, a cable or similar with an appropriate adapter, attaches to or accesses the vehicle power system. One or more battery devices or systems may be provided in the vehicle mounted device in order to prevent complete power down of the vehicle mounted device and/or components.

Preferably, particularly in the temporary delivery vehicle embodiment, all of the components are typically mounted in a housing with one electrical connection to the housing in order to power the components therein.

The subsystem also preferably includes at least one identification tool associated with the vehicle mounted device to uniquely identify the vehicle mounted device within the system. As mentioned above, the identification tool may be attached to the vehicle mounted device, or alternatively, can be provided separately to the vehicle mounted device, but associated with the vehicle mounted device.

Any type of identification tool can be used and the configuration will typically depend upon the type of vehicle mounted device. The identification tool can be or include a barcode device, a radio frequency identification chip or tag or other type of device which has or is associated with, a unique identification code or similar to uniquely identify the tool and thereby the vehicle mounted device, within the system. The identification tool will preferably allow information collected in relation to one vehicle mounted device to be identified as being associated with or collected from that particular vehicle mounted device.

The identification tool is used to identify the vehicle mounted device and through the vehicle mounted device, the delivery vehicle. The identification tool will normally allow permanent identification of the particular vehicle mounted device with which it is associated.

As mentioned above, the identification tool is typically attached to the vehicle mounted device or a part thereof.

The system of the present invention also includes a central server processing system to receive the location data from each of vehicle mounted devices and based on the location data, to transfer information relating to the real-time location of each vehicle to the home base workstation. The central server processing system is normally remotely located from the home base workstation and the respective vehicle mounted devices. The central server processing system is typically associated with an automatic vehicle location system which provides information to the central server processing system. Preferably, this system is not an event activated tracking system but an automated vehicle location system based on the provision of second by second location data provided from the at least one location receiver of each vehicle mounted device. The central server processing system therefore preferably includes management functionality in addition to the automatic vehicle location system functionality (which is may simply adopt from an external system) allowing a company to manage a fleet of vehicles each of which is associated with a particular home base.

The automatic vehicle location system may be operated or administered by a system administrator which is separate to the operator of the autonomous food delivery vehicle. Normally, the automatic vehicle location algorithm is located on a server or web platform and the location information is used by the automatic vehicle location system and the server or web platform then transmits information relating to the real-time location of each vehicle to the home base workstation of the particular vehicle. Therefore, the automatic vehicle location system which is a part of or is accessed by the central server processing system is typically a “fat client” undertaking information processing and storage by or on a computer network or server and then provides that information to the central server processing system of the present invention.

The home base workstation preferably receives information from the central server processing system. The home base workstation may provide information to the central server processing system for example, information relating to login or association of vehicle mounted devices with particular vehicles and/or drivers.

The central server processing system may interact with other components of the system to transfer information to and/or receive information from other components of the system. According to the most preferred embodiment, the central server processing system communicates with the homebase workstations of a number of different home bases and also stores or causes information to be stored in an information log which is accessible by a corporate manager of the respective home bases. In a conventional delivery network, each of the vehicles typically works from home base and each homebase has a particularly defined delivery area. Therefore, information in relation to each vehicle should be available at each homebase as well as to the overall manager of the delivery network.

As mentioned above, the automatic vehicle location system is normally external to the particular delivery company and the delivery company simply accesses the automatic vehicle location system via the central server processing system. Communication between the delivery company via the central server processing system and the automatic vehicle location system may be via middleware.

As mentioned above, the central server processing system in association with the automatic vehicle location system is typically responsible for determining the location of the vehicles within the system and for processing information in relation thereto to allow the other components of the system, preferably the homebase workstations, to be “thin clients” or at least “thinner clients” than the central server processing system. The bulk of the processing and storage of information will therefore preferably take place in the central server processing system and/or automatic vehicle location system rather than at the homebase workstations, but the homebase workstations will typically be capable of at least some processing and data storage.

Information is typically accessed within the system through the central server processing system. Queries are generally submitted to the central server processing system and databases storing the information are typically accessed via the central server processing system as required or as pursuant to a request. Preferably, the particular operation of the automatic vehicle location system does not form a part of the present invention which is more directed towards the use of the information, particularly by the homebase workstations and as a part of delivery company management, within the invention.

The system of the present invention also includes a home base workstation including at least one electronic display with a map interface updated in real time indicating the real-time location of the vehicles on the map interface using the information transferred from the central server processing system. Preferably, the information is pushed to the home base workstation from the central server processing system rather than pursuant to a request from the home base workstation.

According to a particularly preferred embodiment, multiple home base workstations are provided in a delivery network and each home base workstation normally has a number of vehicle mounted devices which are particularly associated with that home base workstation. For example, a single company may have a number of stores, and each store may have a number of vehicles which are responsible for delivering the products from each of the stores. Each of the vehicles will normally have a vehicle mounted device assignable to it. Therefore, the home base workstation at each store will typically have the ability to track the location of each of the vehicles which deliver from that store. The company will also typically have management capabilities to track the location of each vehicle from each of the stores as well as to maintain information in relation to each vehicle from each of the stores, but to drill down to each store and preferably, to each vehicle and/or driver in any one or more of the stores. Typically, the system will report the location of each vehicle to its respective home base workstation but will not necessarily report the location to other homebase workstations.

The information provided typically allows the home base workstation to plot the location of each vehicle of that home base on the electronic display on the map interface, in real time.

The at least one electronic display may be of any type. Typically, the electronic display will be a device such as a monitor or view screen. Preferably, the electronic display will display the map interface only and substantially at all times in which the system is operating. Normally, the electronic display will display the location of the vehicles on the map interface without allowing any interaction with the system through the electronic display.

The map interface displayed on the electronic display will preferably be limited to the particular delivery area of the home base from which the vehicle operates or have the particular delivery area of the homebase delineated clearly. One particularly preferred method of delineation is to show the delivery area in full colour and resolution and to display areas outside the delivery area in a darkened or obscured display, which is still visible on the map interface, but which is clearly outside the delivery area. The particular delivery area may have a border surrounding it in order to further demarcate the delivery area. It is particularly preferred according to the present invention that the delivery area be defined as a geo-fence in order to allow a store manager or other operator within a particular home base to identify if a delivery vehicle strays outside the delivery area for the particular store.

The map interface is typically produced by or at the local workstation based on information received from the central server processing system and particularly from the automatic vehicle location system.

The map interface is typically generated using an existing map provider. The most popular map provider will typically be Google Maps. The system of the present invention will typically generate the map interface on the display using information obtained from an existing map provider such as Google Maps. Information obtained from an existing map provider will typically include other information which will also typically be useful to the management of deliveries. This additional information normally includes traffic related information such as traffic density, and speed zones.

Traffic related information functionality normally works by analysing the GPS-determined locations transmitted to a map provider from a large number of cell phone users. By calculating the speed of users along a stretch of road, the map provider is able to generate a live traffic map. The map provider then processes the incoming raw data about cell phone device locations, and then excludes anomalies such as a postal vehicle which makes frequent stops. When a threshold of users in a particular area is noted, the overlay along roads and highways on the map interface typically changes colour. The map interface of the present invention will typically operate to show this type of traffic data in real time in addition to the location of delivery vehicles.

The map interface will also preferably have an automatic zoom function. There will of course be periods where one vehicle having a vehicle mounted device is on a delivery and times where more than one vehicle having vehicle mounted devices are on delivery. The map interface will typically automatically zoom in and/or out to show the delivery area in relation to vehicles on delivery. If only a single vehicle is on delivery, then the map interface will typically zoom in to that particular area and then will expand as more vehicles leave on deliveries and then expand/contract/change shape and focus as required as delivery vehicles return and/or leave.

Preferably, the system of the present invention operates to only show active deliveries in progress on the map interface. Information is typically provided in real time on the map interface updated in real time or near real time. The map interface may be static or fixed and changes displayed in one or more overlays. Normally, an icon is provided for each delivery vehicle. A trip timer and/or leg timer may be provided in order to allow management to view the elapsed time on delivery for each vehicle. Normally, changes in the delivery legs will normally be determined via changes in ignition status of vehicle, collected from the vehicle via the vehicle mounted device as explained above.

There will typically be a number of different legs about which records are logged by the system and which may be illustrated on the map interface or on a related interface in order to allow management of the home base to determine the efficiency of the deliveries. In particular, there will typically be an “outward leg” during which the delivery vehicle has left the store and is on its way to the delivery point. This will typically be indicated on the map interface in a particular way, normally using a particular colour. The colour green is a particularly preferred colour for the outward leg. Preferably, the subsystem determines that the delivery is on the outbound leg through the loading and delivery of the food detected by deployment of the deployable portion. For example, when the employee loads the food into the autonomous food delivery vehicle, there will normally be an “initiate delivery” activation and this can be confirmed using location data as the vehicle moves off.

A second, “at delivery leg” occurs when the autonomous delivery vehicle is at the delivery point. This will typically be indicated on the map interface in a particular way, normally using a particular colour, different to the outward leg colour. The colour dark blue is a particularly preferred colour for indicating that the vehicle is at the delivery point. Preferably, the system determines that the delivery is at the delivery point using location data and this can be confirmed if the verification process commences and then the “at delivery” leg typically ends when the deployable portion closes, signalling that the delivery has been completed and this can be confirmed using location data as the vehicle moves off.

A third, “homebound” leg occurs when the vehicle is returning to the home base. This will typically be indicated on the map interface in a particular way, normally using a particular colour different to both the colour used for each of the outward leg and at delivery leg. The colour orange is a particularly preferred colour for indicating that the delivery vehicle is on the homebound leg. Preferably, the system determines that the delivery driver is on the homebound leg and returning to the home base using location data and the homebound leg ends when the location data matches the home base location.

Additional legs may be provided such as for example where a delivery vehicle takes more than one delivery on a single run. If this occurs, then one or more intermediate delivery legs will typically exist between the “at delivery” leg and the homebound leg. The system will typically have interaction with an order dispatch system or order management system which will typically be able to adjust when a vehicle has been assigned more than one delivery on a single delivery run.

Preferably, the appearance of the preferred icon indicating the delivery vehicle will normally adjust depending upon the particular leg which the delivery vehicle is currently on. Preferably, the preferred icon indicating the delivery vehicle may appear on the map interface when an order is designated to a delivery vehicle but preferably, only appears once the vehicle has actually begun the trip.

The status of the delivery vehicle will preferably be indicated in different ways on the map interface in order to allow a home base manager to easily recognise the legs and distinguish between the legs of each of the deliveries currently in progress. This will typically allow the home base manager to manage the delivery sequence and/or preparation time for products, more easily. As mentioned above, the status of the delivery vehicle and the particular leg of the vehicle, is normally indicated on the map interface using colours but any other identification can be used.

It is further preferred that the speed of the vehicle is indicated on or in relation to the preferred icon indicating the delivery vehicle on the map interface. The preferred icon may also indicate the particular location and/or vehicle designator.

The map interface may not indicate the end point or ultimate destination of the delivery until the end point or ultimate destination is reached. At that time, the status of the delivery will typically change and the representation of the icon will typically change accordingly. The map interface will typically show the path taken by the delivery vehicle, normally both outward and on the return leg until the vehicle arrives at the home base store with the different legs indicated differently and then, once sign in has been achieved, the map interface will typically refresh and remove the path taken. An ETA at the home base may be calculated and displayed on the map interface based on the length of the outward leg and/or prevailing traffic conditions obtained from the map provider.

Normally, if a vehicle with a fitted vehicle mounted device leaves the store without a delivery assigned to it, then the icon on the map interface will typically identify this. Normally, the icon will be coloured red for example, indicating that the vehicle has left the store without assigning a delivery thereto.

Further, if an unassigned vehicle mounted device leaves the store, in other words a vehicle mounted device that has not yet been associated with a vehicle using the assignment system, the icon on the map interface will typically identify this. Again, the icon can be coloured red for example. This allows the home base manager to easily identify that vehicles have left the store either without a delivery or without properly assigning a vehicle mounted device to the vehicle. In instances, assigning a delivery to the vehicle may be a necessary precursor step before the vehicle will leave the home base as until the assignment takes place, the vehicle will typically not have a delivery location, only obtaining a delivery location as a result of the delivery assignment.

Further functionality may be added to the map interface. For example, the map interface may be updated with real-time alerts as to the activity or behaviour of vehicles which are on delivery. For example, a real-time alert may be issued if a vehicle exceeds the speed limit. Preferably, there can be a tiered real-time alert for example, a real-time alert may issue if a vehicle exceeds the posted speed limit on a road by 10 km for a period of 10 seconds or alternatively, a real-time alert may issue if a driver exceeds the speed limit by 15 km at any time regardless of the length of exceeding the speed limit. Typically, the posted speed limit on roads is also obtained from the existing map provider.

Still further, the system is preferably adapted to determine when the vehicle is operating dangerously or harshly. Harsh driving may be defined as excessive acceleration or breaking which due to the provision of second by second data, can be easily determined and can be notified to the system and particularly to the home base manager in order to take remedial action.

The home base workstation and more particularly, a software application operating on the home base workstation, typically interacts with an order dispatch software application and/or a delivery management application. These applications may operate on a network which is different to but accessible by the home base workstation or on a single network accessible by all applications.

Typically, an instore operator will assign deliveries to the vehicle when the delivery is ready for delivery. According to the system of the present invention, when a delivery is assigned in an order management system, information preferably begins to be shared with the autonomous vehicle on board computer device and the automatic vehicle location system operating on the central server processing system in order to log information relating to the delivery. Preferably, the central server processing system will normally assign the particular order or delivery to a particular vehicle and information is thereafter typically collected via the vehicle mounted device in relation to that particular order or delivery.

The home base workstation will preferably have a processor associated therewith in order to generate and display the map interface but also to receive input from at least one input device in order to control the appearance of the map interface as well as interact with software applications operating on the home base workstation or in association with the home base workstation.

The home base workstation will also typically include at least one input device for input of data into the home base workstation. As mentioned above, the home base workstation will normally include at least one processor. Any number and any type of input device can be provided to allow input or interaction with the home base workstation.

According to a particularly preferred embodiment, a touchscreen control panel associated with the processor as a part of the home base workstation will be provided. This is normally in addition to the identification tool reader. Further, there may be other input devices such as a keyboard and/or pointer device such as a mouse, associated with the processor as a part of the home base workstation. The provision of the touchscreen control panel and the keyboard and/or mouse will preferably allow operators at the home base workstation to interact with the system through the touchscreen control panel primarily and the keyboard and/or pointer device as required, given that the electronic display with the map interface is for display only.

Preferably, the touchscreen control panel may be used to control the home base workstation computer processor. As mentioned above, the home base workstation will normally have more limited functionality than the central server processing system, but there will preferably be functionality accessible at the home base workstation for management purposes.

In particular, the home base workstation computer processor will typically generate and display one or more touch actuable “buttons” on the touchscreen control panel. For example, a button is typically provided for each available delivery vehicle to identify the available delivery vehicles to store management and to allow staff to interact with each available delivery vehicle and the system. These buttons will typically appear on the touchscreen control panel as the delivery vehicles return to the home base as detected by the location device operating in association with the home base workstation computer processor.

The particular delivery vehicle button will normally also indicate the status of the delivery vehicle. For example, vehicles on delivery will typically be visually distinguished from those with no assignment but which are available. This will typically allow management to easily identify which vehicles are available and which are not. Normally, in order to associate or assign an order to a vehicle, staff will typically use the identification tool to identify the vehicle to the system using the identification tool reader. The information obtained during this step will also typically be provided to the central server processing system for use by the automatic vehicle location system.

There will also typically be an address look up function “button” and an administration “button”.

An administrator, normally a store manager can typically use the Administration portion of the application operating on the touchscreen control panel to remove vehicles from availability for selection, as required. For example, it will typically be advisable to remove a vehicle which is currently unavailable for delivery, such as one has broken down or is being serviced, from those available for selection. Typically, the administrator will normally do this by marking that particular vehicle as not being capable of selection, until it is re-added to the system.

The administration portion of the application operating on the touchscreen control panel can also be used to manually adjust the zoom level of the map interface on the display. Other parameters may be adjustable using a “settings” functionality accessible through the administration portion of the application.

One or more waypoints may be provided to the vehicle. It may be possible to look at more than one address, and have the system plot that optimum delivery route for more than one address on a single delivery run.

The touchscreen control panel will typically also be capable of displaying a map interface thereon showing vehicle locations relative to the map interface as well as the delivery status. The map interface will typically be similar to that displayed on the electronic display of the home base workstation, but separately from the electronic display at the home base workstation such that the electronic display on the home base workstation always displays a map interface showing the location of the deliveries.

The touchscreen control panel may also indicate the connection status to the central server processing system and/or the automatic vehicle location system.

The home base workstation of the present invention also preferably includes at least one identification tool reader to read the identification tool of each vehicle mounted device to uniquely identify the vehicle mounted device as well as information and data pertaining thereto within the system. In essence, the system of the present invention will maintain information based on the identity of the vehicle mounted device and the association of each vehicle mounted device to an individual vehicle.

Each of the vehicles within the system may have a unique profile which will typically be stored in a database associated with the system. The home base administrator, manager or store manager will normally have the ability to approve profiles.

As mentioned above, the system for real-time monitoring of vehicles will preferably integrate with a delivery management system. It is also preferred that the system for real-time monitoring of vehicles will integrate with an online ordering system provided by a company providing the products to be delivered. In particular, a portion of the information from the system for real-time monitoring of vehicles may be provided to an online ordering system in order to allow a customer to receive real-time updates about the location of their order during the delivery process.

According to a preferred form, an interface is typically produced based on information from the system for real-time monitoring of vehicles to show the location of the delivery relative to the customer or delivery point once the delivery has moved within a particular separation distance from the customer or delivery point. This will allow a user to identify how far away the delivery actually is in order to prepare for the delivery. According to the most preferred form, when on multiple delivery runs, the information provided will typically be for the particular customer's delivery only, and not the entire run.

A middleware software application may be provided that allows external access to the central server processing system on a tablet or smartphone for example. Preferably, this middleware application will allow a store manager or franchisee for example to access the management portion of the system which is also accessed from the home base workstation.

In a particularly preferred form, a software application is provided with embedded functionality allowing the production of a location interface showing the delivery. Normally, the embedded functionality will be a part of a whole of concept online order and delivery tracking system. This functionality will typically operate as an extension of the system for real-time monitoring of vehicles of the present invention and information gathered from the system for real-time monitoring of vehicles will typically be provided to the whole of concept online order and delivery tracking system. This will typically be a web-based system with one or more downloadable software applications which can be downloaded to a customer personal computing device such as a smart phone or tablet for example.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic isometric view from the front of an autonomous food delivery vehicle according to a preferred embodiment of the present invention.

FIG. 2 is a schematic isometric view from the rear of the vehicle illustrated in FIG. 1.

FIG. 3 is a schematic front elevation view of the vehicle illustrated in FIG. 1.

FIG. 4 is a schematic isometric plan view of the vehicle illustrated in FIG. 1.

FIG. 5 is a plan view of the vehicle illustrated in FIG. 1.

FIG. 6 is a front elevation view of the vehicle illustrated in FIG. 1.

FIG. 7 is a side elevation view of the vehicle illustrated in FIG. 1.

FIG. 8 is a schematic illustration of the vehicle illustrated in FIG. 1 mid delivery.

FIG. 9 is a schematic illustration of the vehicle illustrated in FIG. 1 showing the preferred visual indicators.

FIG. 10 is a schematic illustration showing the general delivery process according to a preferred embodiment of the present invention.

FIG. 11 is a schematic illustration of the system of the present invention according to a preferred embodiment.

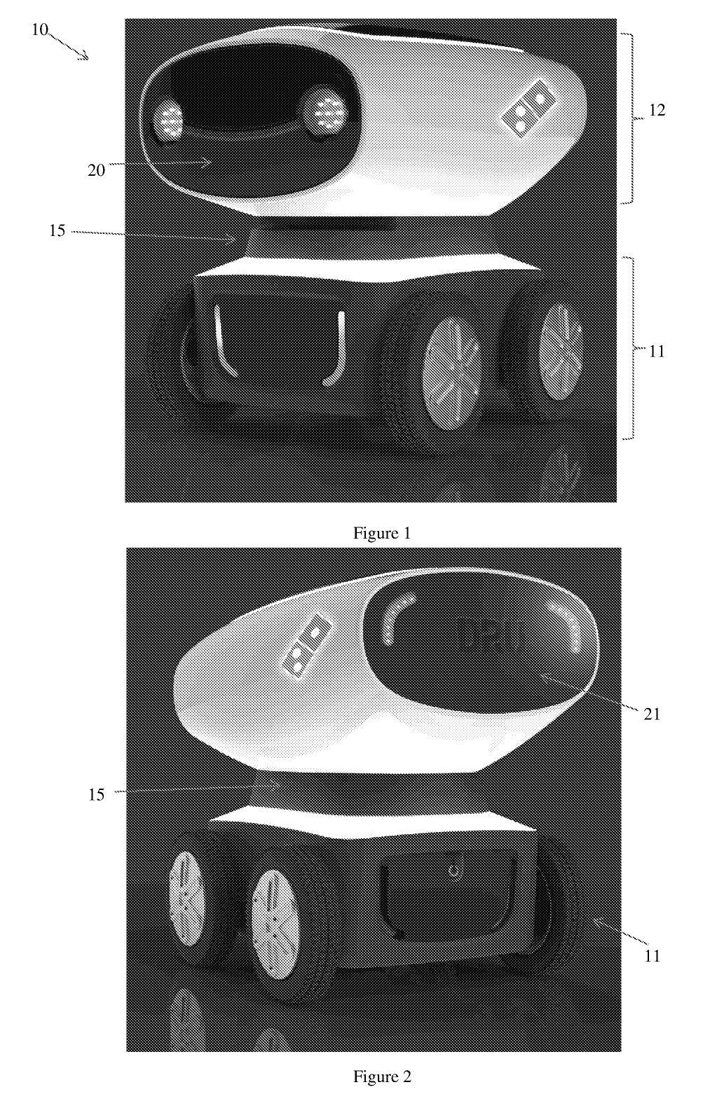

### DESCRIPTION OF EMBODIMENTS

According to a particularly preferred embodiment of the present invention, an autonomous delivery vehicle is provided.

The autonomous delivery vehicle 10 illustrated in the accompanying Figures includes a motorised, mobile base unit 11 with an on-board computer configured with software for navigation and collision avoidance, a wireless communication module to enable sending and receiving of information to and from the delivery vehicle, at least one location receiver to obtain location data indicative of a location of the vehicle in real time or near real time and at least one detection device to detect features in the local environment for navigation and collision avoidance.

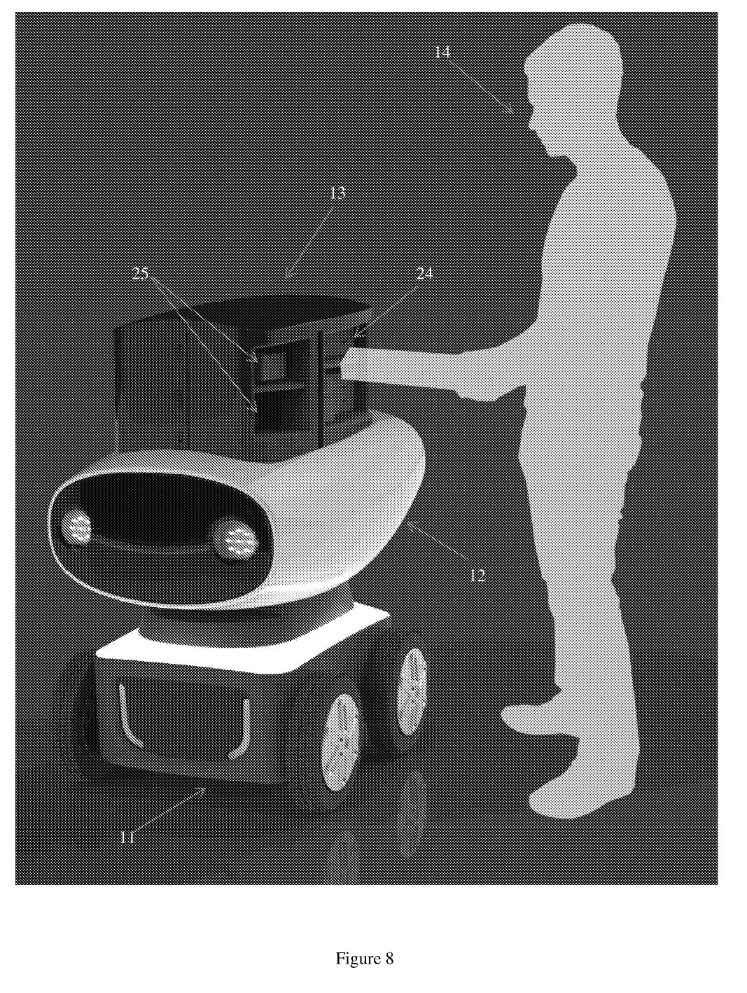

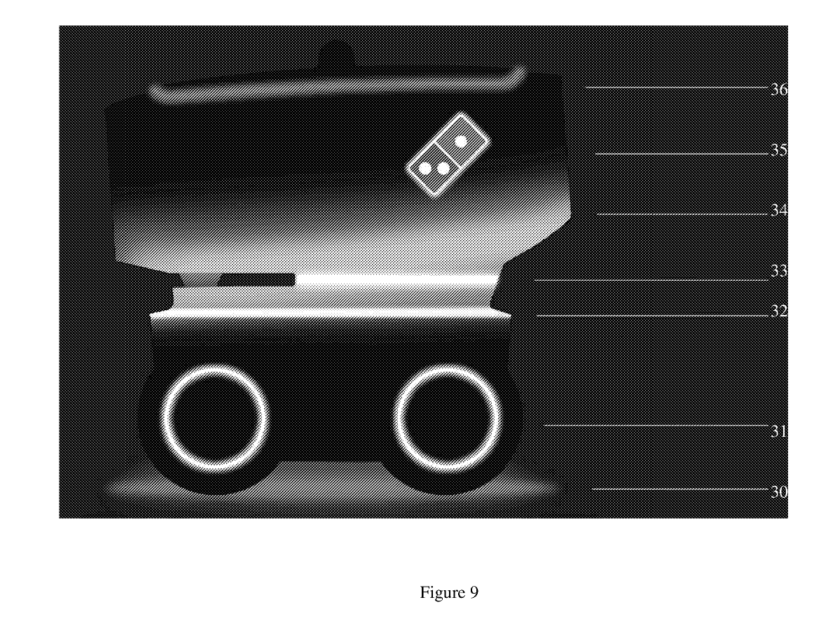

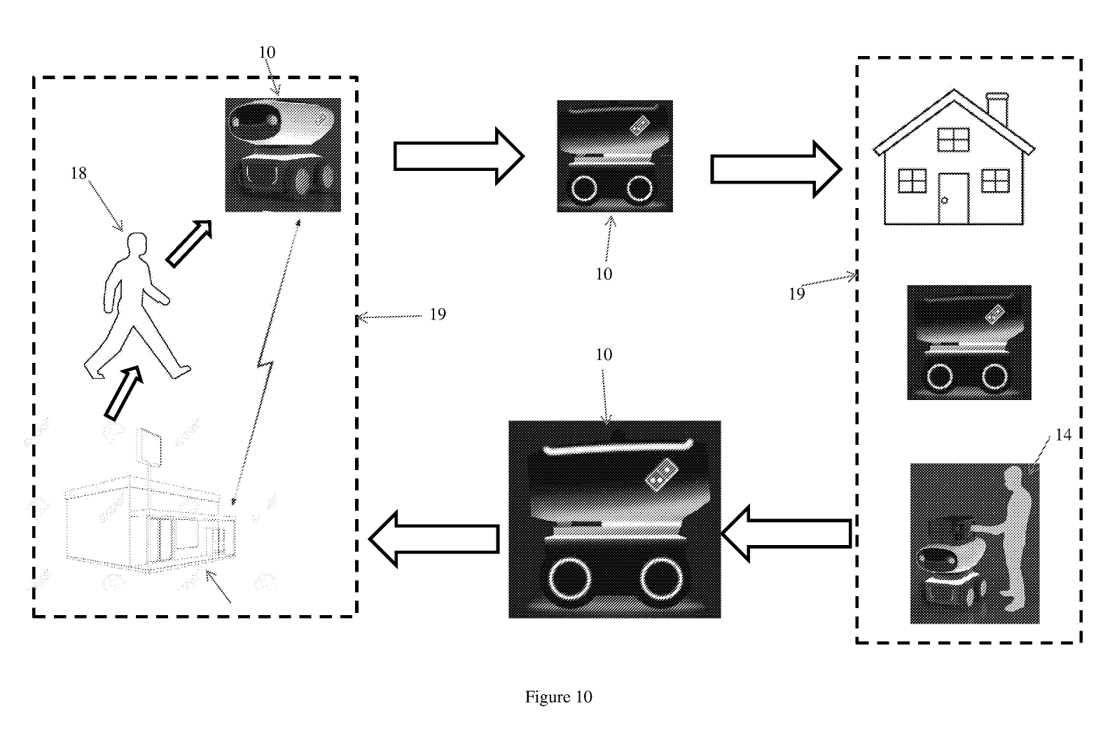

The autonomous delivery vehicle 10 also includes a delivery unit 12 mounted to the mobile base unit 11 for containing one or more items during delivery to allow a customer 14 to remove items stored therein once the delivery vehicle 10 has reached a delivery location. As illustrated in FIG. 8 in particular, the delivery unit 12 mounted to the mobile base unit 11 has a deployable portion 13, movable between a stored position for containing one or more items during delivery and a service position (illustrated in FIG. 8) in which the deployable portion 13 is at least partially outside the delivery unit 12 to allow the customer 14 to remove items stored therein.

The autonomous delivery vehicle 10 of the present invention is particularly adapted for delivery of fresh food, and particularly, home delivery of a meal provided by a food preparation store. The vehicle can deliver food that has been prepared at the food preparation store which is hot and/or cold. For the purposes of the present invention, the term “food” includes beverages as well.

The autonomous vehicle of the preferred embodiment utilises a base unit 11 having more or less known technology for providing a mobile base unit which is capable of navigation and collision avoidance in order to autonomously move from one location to another. The vehicle will typically be speed limited. The vehicle will normally be software controlled in order to be substantially autonomous and preferably provided with an artificial intelligence allowing self navigation and collision avoidance but with human intervention possible in situations that the software cannot overcome. The prototype uses a base unit from a T40 autonomous robotic target built by Marathon Targets and which is the subject of patent applications owned by MARATHON ROBOTICS PTY LTD.

Generally, the vehicle 10 will be relatively small having a footprint of approximately 1 m×1 m but the weight of the vehicle will typically be substantial, mainly due to the inclusion of the power plant in the vehicle. In some embodiments, the vehicle may weigh upwards of 250 kg.

The vehicle 10 will typically be an electric vehicle, but alternative outlets may be provided. According to a preferred embodiment, the vehicle will normally have one or more on-board storage batteries which can be recharged in order to provide power to one or more electric motors to drive the preferred wheels. It is preferred that the vehicle be provided with at least 4 wheels and a four-wheel-drive operation is preferred for safety and stability reasons. Preferably the wheel is provided will be punctured preferably rather than tracks in order to limit maintenance and the potential for damage.

As will be relatively clear from the above, the vehicle will typically be self driving and self navigating. The vehicle typically is capable of operating at substantial distances, preferably up to approximately 20 to 30 km. The vehicle will be capable of out of line of sight operation.

The vehicle 10 of the present invention includes a motorised base unit 11. Preferably, the motorised base unit 11 will be self-contained, mobile and operate substantially autonomously during the delivery process. Typically, the motorised base unit 11 is generally rectangular being provided with 4 wheels, one at each of the corners of the generally rectangular unit. The delivery unit 12 is located on top of the motorised base unit 11 and separated from the base unit 11, normally through the provision of an intervening wall or similar. Preferably, a neck portion 15 is provided between the motorised base unit 11 and the delivery unit 12 and the delivery unit 12 and the motorised base unit 11 are both larger than the neck portion 14.

As mentioned above, the motorised base unit 11 is typically powered electrically and includes one or more on-board batteries. The weight of the batteries in the base unit 11 will typically increase the stability of the base unit and reduce the chance that the vehicle will tip.

The motorised base unit may be made from any material, but typically, the drive and operational components of the base unit will be contained in a metal enclosure but one or more external panels of the motorised base unit may be provided manufactured from different materials for aesthetic purposes.

One or more cameras or other image capturing devices may be provided on the motorised base unit or the delivery vehicle in general in order to monitor and/or capture the surrounds whilst the vehicle is on delivery. Normally, this will be capture of images on a real time and preferably substantially continuous basis by video capture. The captured images may be transmitted to a remote locality for monitoring and/or stored on board.

The motorised base unit will typically operate on skid steer principles in order to provide a very small turning circle and high manoeuvrability. The motorised base unit will be of robust construction given that it will likely be deployed into adverse weather conditions and possibly adverse to rain conditions. The motorised base unit will also typically be substantially waterproof in order to protect the components within.

The autonomous delivery vehicle of the present invention also includes an on-board computer configured with software for navigation and collision avoidance. The on-board software will typically allow autonomous operation to travel from the home base to one or more delivery locations and return to home base substantially without human intervention unless human intervention is required for situations not solvable by the software.

Normally, the on-board computer will be associated with the wireless communications module, the location receiver and the at least one detection device and will typically use inputs from these components to autonomously navigate from the home base to the at least one delivery location and return to the home base with the navigation including avoidance of collisions during the travel.

The on-board computer will typically operate navigation and collision avoidance software but the on-board computer will also typically include a software application to accomplish or partake in the customer identity verification process at each delivery location, before the delivery unit is deployed. The on-board computer will therefore have one or more separate subsystems with at least one subsystem including hardware and software allowing autonomous navigation and collision avoidance of the vehicle to one or more delivery locations and at least one subsystem including hardware and software controlling access to the food delivery unit.

The on-board computer is typically capable of receiving delivery instructions from a point of sale or store management computer system in order to obtain the one or more delivery locations. The on-board computer is preferably also capable of obtaining or being provided with real-time map or outing information for use in navigation and/or collision avoidance.

The autonomous delivery vehicle of the present invention also includes at least one wireless communications module allowing for communication to and/or from the vehicle. In this way, the autonomous delivery vehicle can send and receive information in relation to its location and status and receive updates to allow more efficient operation and/or delivery. Normally, instructions are issued to the on-board computer of the autonomous delivery vehicle via the at least one wireless communications module. Requests from the autonomous vehicle for further information or instructions can be sent via the at least one wireless communications module, updates can be received substantially in real time and importantly, second by second data as to the location and speed of the vehicle as well as vector data can be provided from the autonomous delivery vehicle to a remote monitoring system. Preferably, the at least one wireless communication module will send second by second data as to the location and speed of the vehicle as well as vector data to at least one remote location, normally to a monitoring system to allow the monitoring system to convey this information to the home base (the information can be sent directly to the home base) and/or other interested parties such as for example the ordering customer as be explained further below.

The autonomous delivery vehicle of the present invention also includes at least one detection device to detect features in the local environment for navigation and collision avoidance. One or more detection devices can be used and any type or combination of detection devices can be used. Particularly preferred are devices that allow the autonomous delivery vehicle to navigate and identify objects using radar, lidar, location technologies such as GPS, odometry and/or computer-aided vision, virtual reality or augmented reality technology. Lidar is particularly preferred for use as the primary detection mechanism and appropriate hardware and (on-board) software is typically provided.

In use and as illustrated schematically in FIG. 10, the autonomous delivery vehicle 10 is loaded with prepared food by an operator 18 at a home base 16, normally the food preparation store 17 and provided with the delivery location. The autonomous delivery vehicle 10 is then “locked”, leaves the food preparation store and navigates autonomously to one or more delivery locations 19 where the customer 14 can access the food for removal after an appropriate verification process has taken place and the autonomous vehicle 10 then navigates back to the home base 16 (or to one or more further delivery locations and then back to the home base) for further deployment or storage.

As mentioned above, the delivery unit 12 is typically mounted to the motorised base unit 11, above the base unit 11, typically on a neck portion 15.

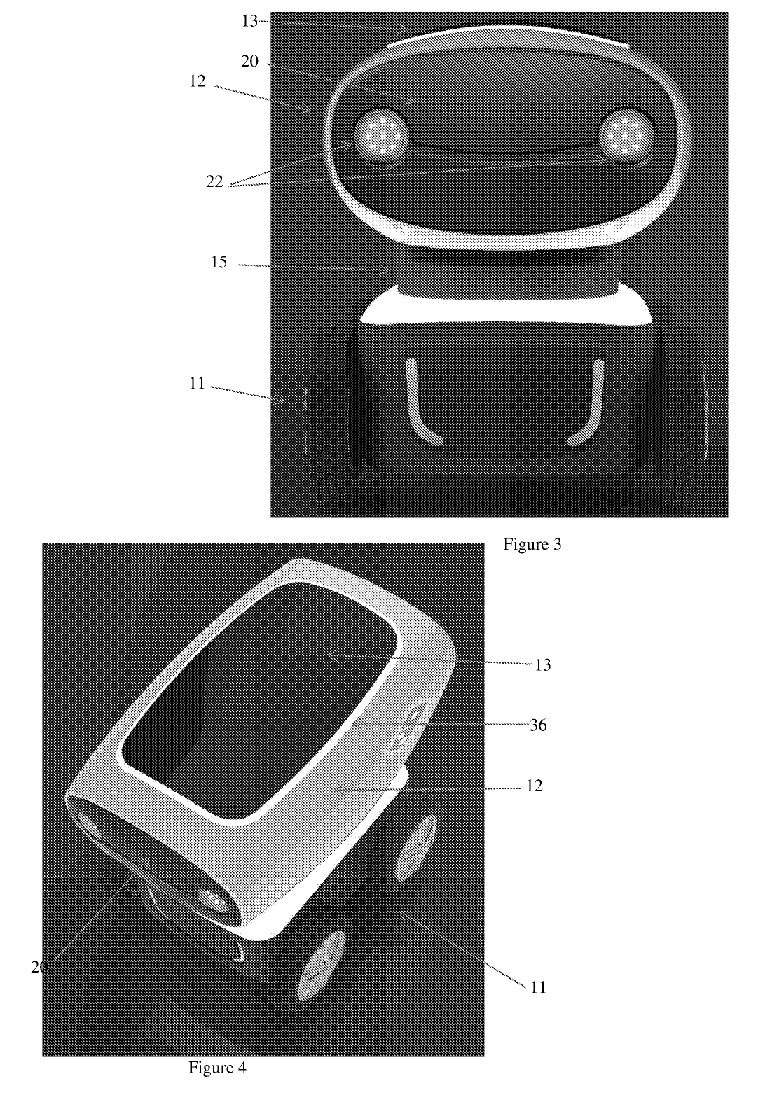

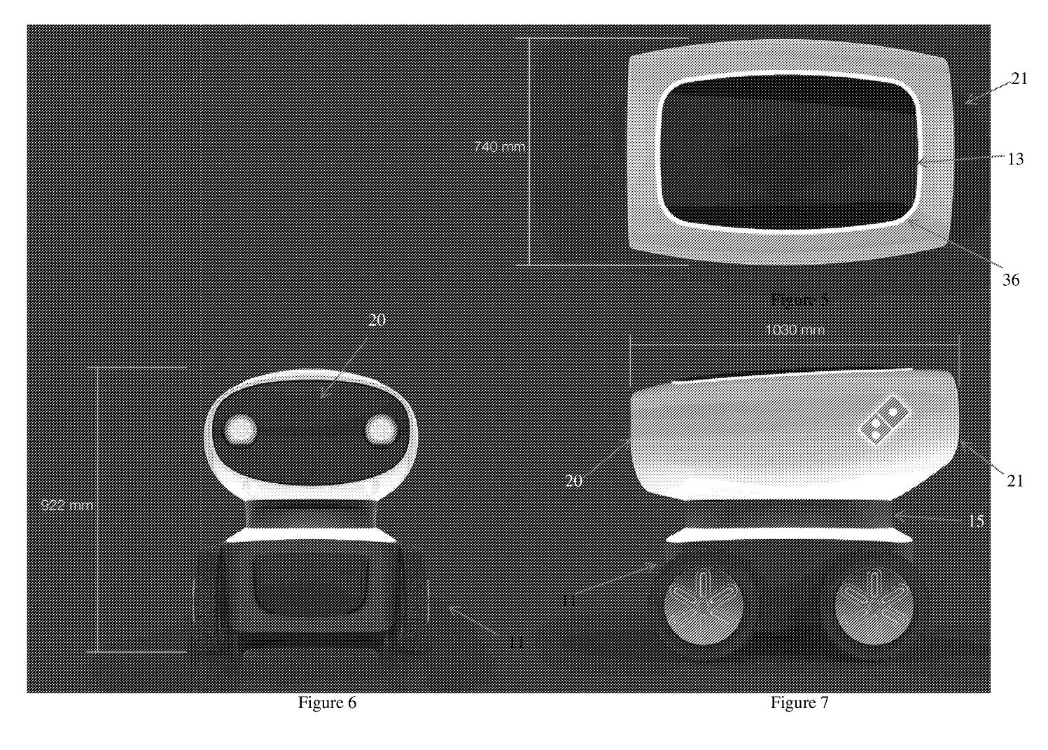

As illustrated, the delivery unit 12 includes an external housing which defines an outer shape of the delivery unit 12 and is at least partially arcuate for aesthetic reasons. The housing illustrated has a substantially planar front wall 20 and rear wall 21. AS illustrated in FIG. 3, the front wall 20 of the delivery unit 12 is provided with a pair of headlights 22 in order to illuminate forwardly of the food delivery vehicle 12 and the headlights 22 may be conventional lights. In the embodiment, the headlights are made up of a number of high intensity LED's. In contrast, the rear wall 21 of the delivery unit 12 is provided with a pair of tail lights and/or brake lights 23 in order to allow a user to more easily identify the autonomous vehicle 10 and/or indicate to users located rearwardly of the vehicle when the vehicle is braking.

The external housing of the delivery unit 12 is at least partially hollow defining an internal volume. The deployable portion 13 is located within the internal volume of the delivery unit 12 in the delivery condition and is selectively deployable to a location partially outside the external housing to allow a customer 14 to access and remove the food stored within the deployable portion 13. In the preferred embodiment illustrated in FIG. 8, the deployable portion 13 raises and lowers substantially vertically relative to the external housing as this will contribute to maintaining the stability of the vehicle 10.

As illustrated in FIG. 8, the deployable portion 13 is divided internally into compartments with different functionalities, for example, some of the compartments are heated or hot compartments 24 adapted to temporarily store heated food and some of the compartments 25 are cooled or cold compartments adapted to temporarily store cooled or frozen food. Where these different functionalities are provided in the same deployable portion 13, the compartments 24, 25 are visually distinct from one another, for example using colour coding to represent the different functionalities. In one preferred embodiment, the cool or cold compartments may be provided with blue colouring or highlights and the warm or hot compartments provided with red colouring or highlights in order to allow the customer to easily identify the function of the compartments. This may also increase the safety of the device with the customer being warned of warm or hot compartments prior to making contact with those compartments.

In a particularly preferred embodiment, the delivery unit 13 deploys once the delivery location 19 has been reached and the customer identification verification process has been completed.

The verification process is preferably achieved through the provision of a verification code or identifier by the customer to the autonomous delivery vehicle and preferably, to the software operating on the on-board computer in order to be compared against a verification code or identifier provided at the time the order is made. Typically, the verification code or identifier is created and/or issued upon payment for the order by the ordering customer and is typically provided to the ordering customer upon payment. This is typically achieved using a personal computing device such as a smart phone 26 upon which the majority of ordering customers now order this type of delivery. In this case, the verification code or identifier can be provided directly to the smart phone 26 of the ordering customer once assigned, typically by a software application operating on administration server 27. If the order is made on a non-mobile computing device, the customer can elect to have the verification code or identifier forwarded to a mobile or personal computing device.

Typically, the ordering customer will take the smart phone 26 upon which the order was made with them to collect their food from the autonomous delivery vehicle 10. The verification process can be initiated a variety of ways, one way in which it may be initiated is simply through proximity of the smart phone 26 to the autonomous delivery vehicle 10. In other words, once the smart phone 26 moves within range of the autonomous delivery vehicle 10, the verification process may be initiated automatically. Alternatively, the verification process may be manually commenced by the customer once they are close to the autonomous delivery vehicle 10.

Preferably, the at least one wireless communications module of the autonomous delivery vehicle may be used to communicate with the mobile or personal computing device of the customer. One mechanism for doing so is Bluetooth. For example, Bluetooth allows the identification of electronic devices to one another and either the autonomous delivery vehicle can “find the mobile or personal computing device of the customer or vice versa. Once a communication pathway has been established between the devices, the verification code may be transmitted from the mobile or personal computing device of the customer to the autonomous food delivery vehicle. The verification code received by the on-board computer of the autonomous delivery vehicle can be compared to the verification code created and/or issued upon payment for the order by the customer and if the verification codes match one another, then the deployable portion deploys. If the verification codes do not match each other, then the deployable portion does not deploy, and remained secured within the autonomous food delivery vehicle.

The verification process may include multifactor verification. For example, the verification process may include the verification code and additionally may require the presence of a particular smart phone 26 from which the order was placed within a particular proximity to the autonomous delivery vehicle in order that the autonomous delivery vehicle 10 can verify both the code, and that the code was issued to and from the particular mobile computing device.

The verification code creation and/or issue, is typically undertaken by a software application which may be related to or associated with the software application through which the customer orders the food. The verification code software may allow the verification code to be sent or forwarded to a third-party to allow a third-party to receive delivery of the ordered food. For example, a parent may order a food delivery for children to be delivered to the children at a residential address and may therefore forward the verification code to the children to allow them to access the autonomous delivery vehicle to receive delivery of the food ordered by their parents if their parents are at a remote location from the residential address.

Once the verification process has been completed, that is the verification code provided to the autonomous delivery vehicle 10 by the customer 14 (preferably via the smart phone 26), matches the verification code relating to the particular delivery provided by the ordering software, the deployable portion 13 deploys, allowing the customer 14 to remove the items from the deployable portion 13. The deployable portion 14 then closes and locks in order to secure the deployable portion 13 within the delivery unit 12 once more. The closing process may be actuated by the removal of items and therefore, one or more weight sensors may be provided in order to sense changes of weight in the deployable portion or alternatively, a manually actuable button or similar may be provided on the inside of the deployable portion 13 in order to allow the customer 14 to close the deployable portion 13 once they have removed their food. Typically, safety features will be provided to prevent the deployable portion 13 closing prematurely in order to minimise injury to customers or third parties.

The autonomous delivery vehicle may further include the ability for vehicle to contact the customer directly once the delivery location has been reached if verification is not initiated within a particular time period. This may include via text message or telephone or over a computer network such as the cloud 28 with an automated message such as “your delivery has arrived and is awaiting collection”. Typically, the contact details will be provided to the autonomous delivery vehicle 10 with the order information (or will be stored on server 27 and forwarded as required) and the on-board computer may action the contact if delivery location has been reached if verification is not initiated within a particular time period.

The motorised base unit will typically include at least one, and typically a number of different illumination sources provided for different purposes. In addition to the headlights 22 and taillights 23, lighting 30 is provided beneath the motorised base unit 11 to illuminate downwardly in order to show the path or the road surface over which the base unit 11 is travelling. The wheel hubs are provided with reflective tape 31 and a reflective tape or strip 33 is provided around the neck of the vehicle 10.

An upper portion 32 of the motorised base unit 11 is provided with upwardly directed lighting in order to cast light 34 onto the delivery unit 12. The logo 35 of the delivery company is also illuminated.

Whilst illumination sources will typically be provided, it is also preferred that other visual indicia be provided such as reflective portions, luminescent portions, photoluminescent portions and the like in order that the motorised base unit and the autonomous vehicle in general be identified well and capable of being clearly seen even in low light conditions.

The autonomous delivery vehicle 10 also has a visual indicator 36 which is variable to indicate the delivery status of the food delivery vehicle 10. The visual indicator enables customers and third parties to distinguish between a delivery vehicle 10 which is en route to a delivery location, allow identification of when verification is being undertaken and when a delivery vehicle is en route to the home base following a completed delivery to a customer. In the preferred form, the visual indicator is a lighting strip 36 provided circumferentially at least partially about an upper portion of the deployable portion 13 on top of the delivery unit 12 and capable of being lit in various colours to distinguish between the particular phases of delivery.

The preferred colour system is designed in the corporate colours of the provider of the delivery service. For example, the lighting strip 36 is illuminated in the colour red to signify that the delivery vehicle 10 is on the outbound leg to a delivery location, the lighting strip 36 is illuminated in the colour blue when the autonomous delivery vehicle 10 is undertaking the verification process and the lighting strip 36 is illuminated in the colour white to signify that the delivery vehicle 10 is on the return leg to the home base 16.

The autonomous delivery vehicle 10 of the present invention will also typically include one or more antitheft or anti-tampering features in order to prevent theft or tampering with the food in the delivery unit and/or with the vehicle itself. For example, one or more alarms or warnings may be triggered if the food delivery vehicle is interrupted order averted or attempted to be interrupted or diverted from the plotted or selected delivery path. Typically, the warning will be issued, typically either audibly and/or visibly and if the warning is not effective, then an audible alarm will typically be issued.

If the autonomous delivery vehicle is tampered with or an unauthorised attempt is made to divert the autonomous delivery vehicle from the plotted or selected delivery path, the one or more wheels on the motorised base unit may be locked, either by the on-board computer or remote monitoring station. Due to the preferred substantial weight of the device, this will make the device particularly difficult to move until the wheels are unlocked again.

Of course, the at least one location receiver such as a GPS receiver can be used to track the location of the vehicle in real time or near real time through communication with one or more satellites 29 in the GPS network. The vehicle may also have the ability to automatically notify home base, or third-party such as a monitoring system or authorities such as the police if tampering or attempts are made to divert the vehicle.

Preferably, the housing of the delivery unit 12 is robust in order to minimise any damage that may be inflicted on the delivery unit 12 and to prevent access to the deployable portion 13 and/or the food within and unless the verification process is undertaken.

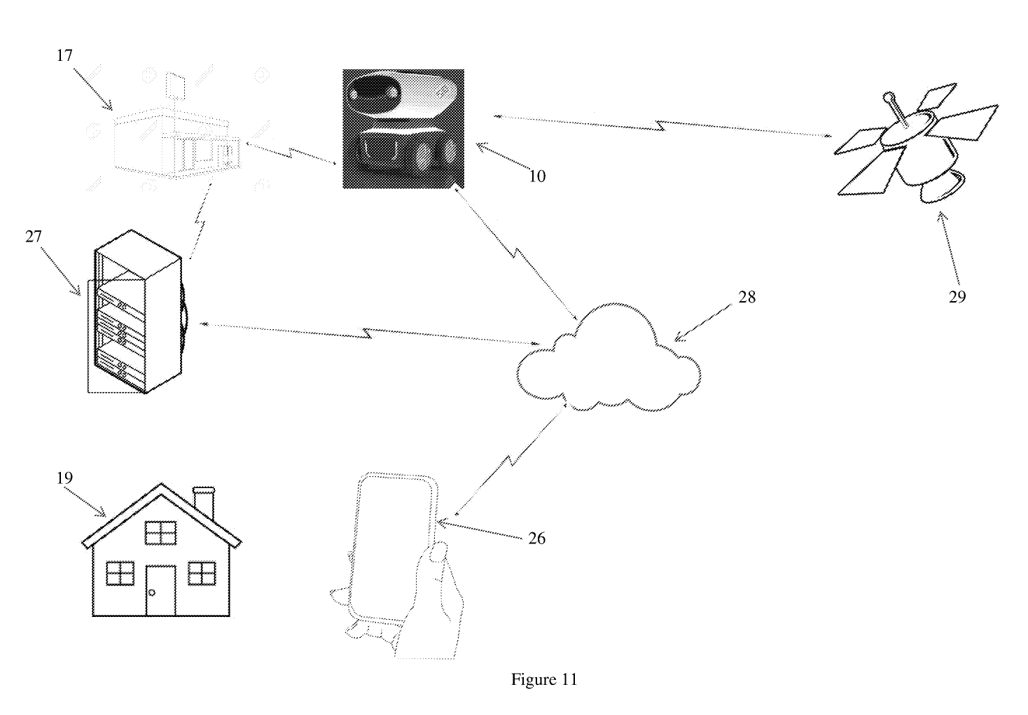

According to the system of the preferred embodiment illustrated schematically in FIG. 11, one or more processing systems may be provided for command and control in addition to the on-board software. The one or more processing systems preferably operate substantially without human intervention and having a communication module to enable sending and receiving of information to and from the delivery vehicle, the one or more processing systems configured to assist the autonomous delivery vehicle with navigation from a home base to a delivery location and back to the home base and collision avoidance whilst in transit

Preferably, the system will provide for real-time tracking of the location and status of the autonomous delivery vehicle and for management thereof.

Instructions and/or updates can be sent from the one or more processing systems to the on-board computer and/or software for action. For example, a recall to base instruction can be issued, the vehicle can issue alerts to the home base, or one or more external systems can be provided to assist with an/or override the navigation and/or collision avoidance system is present in the vehicle. The one or more processing systems can additionally provide rousing data updates in order to more efficiently plan the delivery and/or may plan delivery routs and transfer these to the autonomous food delivery vehicle.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An autonomous delivery vehicle including
a) a motorised, mobile base unit;
b) an on-board computer configured with software for navigation and collision avoidance;
c) a wireless communication module to enable sending and receiving of information to and from the delivery vehicle;
d) at least one location receiver to obtain location data indicative of a location of the vehicle in real time or near real time;
e) at least one detection device to detect features in the local environment for navigation and collision avoidance; and
f) a delivery unit mounted to the mobile base unit for containing one or more items during delivery to allow a customer to remove items stored therein once the delivery vehicle has reached a delivery location.

2. An autonomous delivery vehicle as claimed in claim 1 wherein the delivery unit is mounted to the mobile base unit preferably has a deployable portion, movable between a stored position for containing one or more items during delivery and a service position wherein the deployable portion is at least partially outside the delivery unit to allow a customer to remove items stored therein.

3. An autonomous delivery vehicle as claimed in claim 1 wherein the autonomous delivery vehicle has at least one visual indicator which is variable to indicate the delivery status of the food delivery vehicle.

4. (canceled)

5. (canceled)

6. (canceled)

7. (canceled)

8. (canceled)

9. The autonomous vehicle as claimed in claim 1 wherein the delivery unit is located on top of the motorised mobile base unit and separated from the base unit.

10. (canceled)

11. (canceled)

12. (canceled)

13. (canceled)

14. The autonomous vehicle as claimed in claim 1 further including one or more cameras or other image capturing devices in order to monitor and/or capture the surrounds whilst the vehicle is on delivery.

15. (canceled)

16. The autonomous vehicle as claimed in claim 1 wherein the on-board computer is associated with the wireless communications module, the location receiver and the at least one detection device and uses inputs and/or outputs from the wireless communications module, the location receiver and the at least one detection device to autonomously navigate from the home base to the at least one delivery location and return to the home base with navigation including avoidance of collisions during the travel.

17. The autonomous vehicle as claimed in claim 1 wherein the on-board computer operates navigation and collision avoidance software and also includes a software application or subsystem to accomplish or partake in customer identity verification process at each delivery location, before the deployable portion is deployed.

18. The autonomous vehicle as claimed in claim 17 wherein the on-board computer has one or more separate subsystems with at least one subsystem including hardware and software allowing autonomous navigation and collision avoidance of the vehicle to one or more delivery locations, and at least one subsystem including hardware and software controlling access to the food delivery unit.

19. The autonomous vehicle as claimed in claim 1 wherein the on-board computer receives delivery instructions from a point of sale or store management computer system in order to obtain one or more delivery locations and/or other information required or helpful in the delivery process.

20. (canceled)

21. (canceled)

22. (canceled)

23. (canceled)

24. The autonomous vehicle as claimed in claim 1 wherein the delivery unit includes an external housing which is at least partially hollow defining an internal volume and at least one deployable portion is located within the internal volume of the delivery unit in a delivery condition and is selectively deployable to a location partially outside the external housing to allow a customer to access and remove items stored within the at least one deployable portion.

25. The autonomous vehicle as claimed in claim 24 wherein the at least one deployable portion raises and lowers substantially vertically relative to the external housing.

26. (canceled)

27. (canceled)

28. (canceled)

29. (canceled)

30. The autonomous vehicle as claimed in claim 1 wherein the delivery unit deploys only once the delivery location has been reached and a customer identification verification process has been completed.

31. The autonomous vehicle as claimed in claim 1 wherein a verification process is achieved through the provision of a verification code or identifier by the customer to the software operating on the on-board computer in order to be compared against a verification code or identifier provided at the time the order is made.

32. The autonomous vehicle as claimed in claim 1 wherein a verification process is initiated through proximity of the mobile or personal computing device to the autonomous food delivery vehicle.

33. The autonomous vehicle as claimed in claim 1 wherein a verification process is manually commenced by the customer once the customer is close to the autonomous food delivery vehicle.

34. The autonomous vehicle as claimed in claim 31 wherein once a communication pathway has been established between the mobile or personal computing device of the customer and the autonomous food delivery vehicle, the verification code is transmitted from the mobile or personal computing device of the customer to the autonomous food delivery vehicle, which once received by the on-board computer of the autonomous delivery vehicle can be compared to a verification code created and/or issued upon payment for the order by the customer and if the respective verification codes match one another, then the deployable portion deploys and if f the verification codes do not match each other, then the deployable portion does not deploy, and remains secured within the autonomous food delivery vehicle.

35. (canceled)

36. (canceled)

37. (canceled)

38. The autonomous vehicle as claimed in claim 1 wherein the autonomous vehicle contacts the customer directly once the delivery location has been reached if verification is not initiated within a particular time period.

39. The autonomous vehicle as claimed in claim 1 further including at least one visual indicator which is variable to indicate the delivery status of the food delivery vehicle to distinguish between a delivery vehicle which is en route to a delivery location, allow identification of when verification is being undertaken and when a delivery vehicle is en route to the home base following a completed delivery to a customer.

40. (canceled)

41. The autonomous vehicle as claimed in claim 1 wherein the deployable portion into which food is placed for delivery is also be capable of preparing or cooking the food whilst the delivery is in progress.

42. The autonomous vehicle as claimed in claim 41 wherein the autonomous vehicle is provided with a cooking time for food in the deployable portion and is also capable of calculating the estimated time of arrival at the delivery location from data provided by at least one location receiver, the autonomous vehicle can start cooking the food whilst the delivery is underway in order to ensure that the food arrives at the delivery location at substantially the same time that the cooking ends.

43. An autonomous food delivery system including
a) An autonomous delivery vehicle including a motorised, mobile base unit; an on-board computer configured with software for navigation and collision avoidance; a wireless communication module to enable sending and receiving of information to and from the delivery vehicle; at least one location receiver to obtain location data indicative of a location of the vehicle in real time or near real time; at least one detection device to detect features in the local environment for navigation and collision avoidance; and a delivery unit mounted to the mobile base unit for containing one or more items during delivery to allow a customer to remove items stored therein once the delivery vehicle has reached a delivery location;
b) One or more processing systems operating substantially without human intervention and having a communication module to enable sending and receiving of information to and from the delivery vehicle, the one or more processing systems configured to assist the autonomous delivery vehicle with navigation from a home base to a delivery location and back to the home base and collision avoidance whilst in transit.

44. (canceled)

45. (canceled)

46. (canceled)
